(19) United States
(12) Patent Application Publication
(10) Pub. No.: US 2011/0220637 A1
(43) Pub. Date: Sep. 15, 2011

(54) Heater Apparatus

(75) Inventor: Wing Hang CHAN, Ma On Shan (HK)

(73) Assignee: WIN GLOBAL ELECTRICAL APPLIANCE LTD, Kowloon (HK)

(21) Appl. No.: 12/723,944

(22) Filed: Mar. 15, 2010

(51) Int. Cl. H05B 3/02

(52) U.S. Cl. 219/546

(57) ABSTRACT

A heater apparatus comprises a housing, and a plurality of heating elements provided in the housing. The housing includes a front side provided with a first heat outlet for spreading heat in a first direction, and a top provided with a second heat outlet for spreading heat in a second direction perpendicular to the first direction. Moreover, the second heat outlet is operable to switch between a closed state for blocking heat spread and an open state enabling heat spread in the second direction.

### FIELD OF THE INVENTION

The present invention relates to electric heaters that may be suitable for indoor or outdoor use.

### DESCRIPTION OF THE RELATED ART

Electric heaters are commonly used for providing heat to rooms and offices. Such heaters usually include a sheet metal housing in which are provided heating elements for converting electric power to heat that can be then transferred to the ambient air by natural convection. In order to maximize the heating action, it is often important to properly direct the heat generated from the heater apparatus. Accordingly, electric heaters have been manufactured in a variety of forms.

One known type of electric heater is the baseboard heater. Such heaters include an elongate housing that is intended to be placed horizontally at the juncture of a wall and a floor in use. Another known type of electric heater has a relatively tall, upright housing mounted on support legs. Heated air can exit through an air outlet formed substantially throughout the front side of the upright housing. In some variant designs, the upright housing may also be provided with an opening on the top to add heat exit paths. During operation, heat can accordingly spread through the multiple openings to warm the surrounding space. The ability to spread heat along multiple paths can allow to warm a closed space (such as a room) in a faster manner, but may not be suitable when only local heating action is desired. For example, a user seated outdoor may only need local heating from a front direction. In this case, wasted heat may be dissipated through the unused spreading paths provided on the electric heater.

Therefore, there is presently a need for a heater apparatus that can address the foregoing issues.

### SUMMARY

The present application describes a heater apparatus that can address the foregoing issues. In one embodiment, the heater apparatus comprises a housing, and a plurality of heating elements provided in the housing. The housing includes a front side provided with a first heat outlet for spreading heat in a first direction, and a top provided with a second heat outlet for spreading heat in a second direction perpendicular to the first direction. Moreover, the second heat outlet is operable to switch between a closed state for blocking heat spread and an open state enabling heat spread in the second direction.

At least one advantage of the heater apparatus described herein is the ability to selectively open or close at least one of a plurality of heat outlets so that heat can be spread along one or more privileged directions. Accordingly, the heater apparatus can be configured in a more versatile manner for adapting to different situations of use.

### BRIEF DESCRIPTION OF THE DRAWINGS

FIG. 1 is a perspective view illustrating one embodiment of a heater apparatus;

FIG. 2 is an exploded view of the heater apparatus shown in FIG. 1;

FIG. 3 is a front view of the heater apparatus shown in FIG. 1;

FIG. 4 is a top view of the heater apparatus shown in FIG. 1;

FIG. 5 is a left side view of the heater apparatus shown in FIG. 1;

FIG. 6 is a right side view of the heater apparatus shown in FIG. 1;

FIG. 7 is a schematic view illustrating one embodiment of a heat outlet provided on a top of the heater apparatus shown in FIG. 1; and

FIG. 8 is a schematic view illustrating the operation of the heat outlet shown in FIG. 7.

### DETAILED DESCRIPTION OF THE EMBODIMENTS

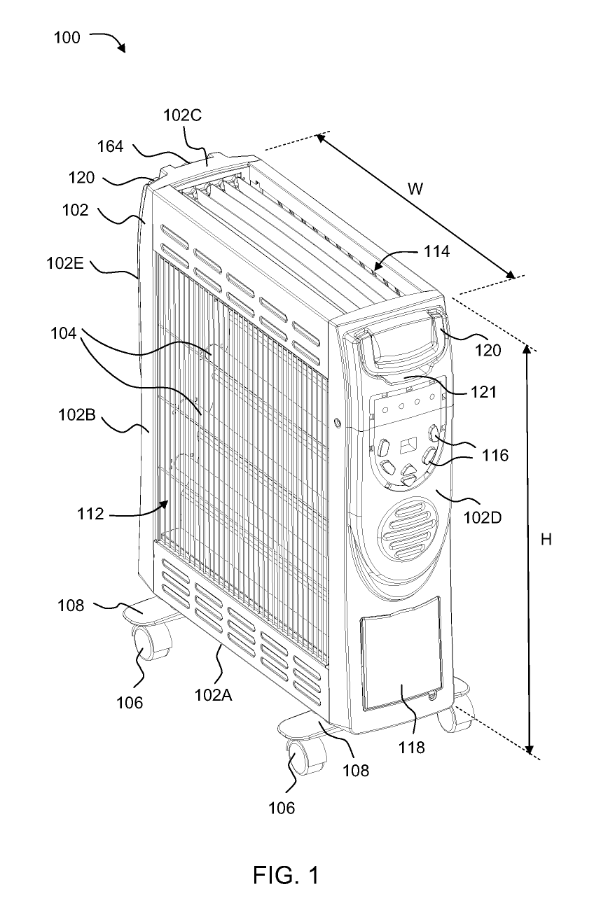

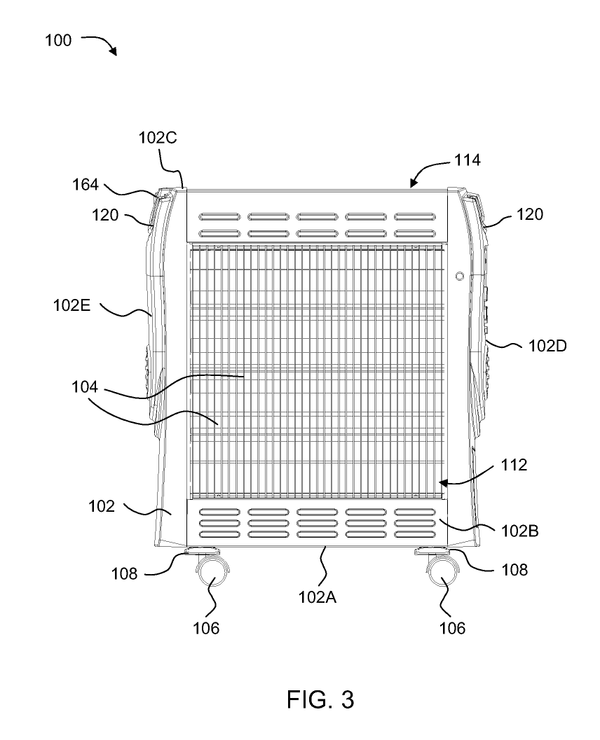

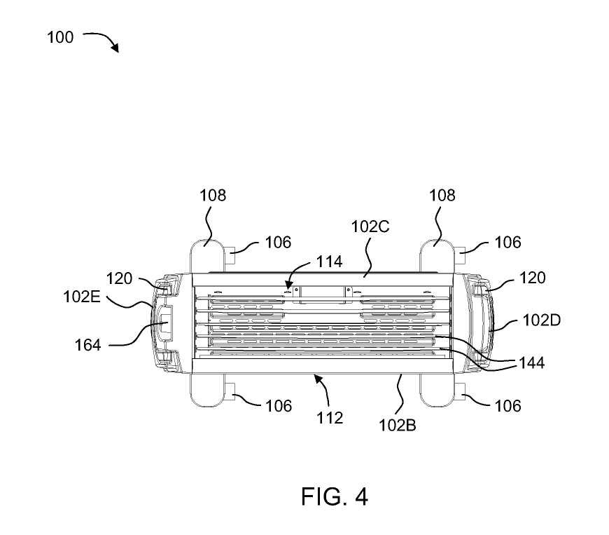

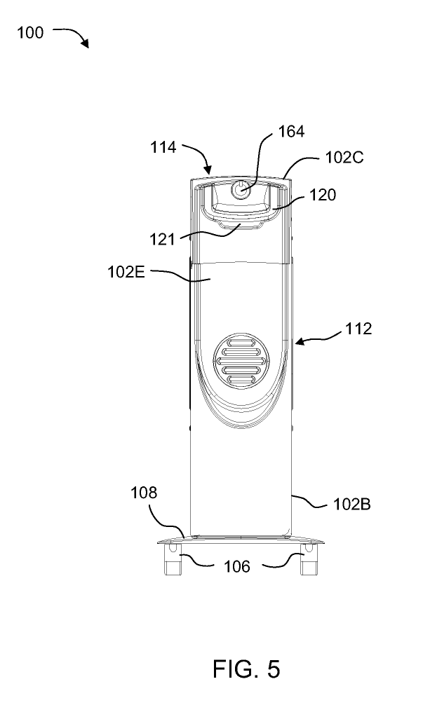

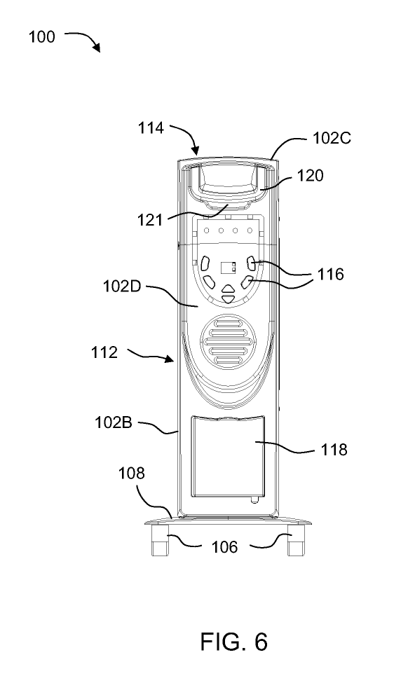

FIG. 1 is a perspective view illustrating one embodiment of a heater apparatus 100, and FIGS. 3-6 are different side views of the heater apparatus 100. As shown, the heater apparatus 100 can be embodied as an upright heater adapted to irradiate heat to ambient air. Examples of such heater can include, without limitation, dual-radiant convection heaters capable of spreading heat along two different directions. The heater apparatus 100 can comprise a housing 102 having an internal volume in which are mounted a plurality of heating elements 104. Examples of the heating elements 104 can include, without limitation, infrared heating elements, halogen-heating elements, thermal resistive elements, or like devices capable of converting electric energy into heat. The heater apparatus 100 can stand on a plurality of wheels 106 that are provided on legs 108 affixed to a bottom 102A of the housing 102 for facilitating transport of the heater apparatus 100. A front side 102B of the housing 102 includes a first heat outlet 112 through which heat generated by the heating elements 104 can be spread outside the housing 102 in a first or lateral direction. A top 102C of the housing 102 also includes an adjustable second heat outlet 114 that can be operable to close or open for selectively allowing heat generated by the heating elements 104 to be spread outside the housing 102 in a second or upward direction perpendicular to the first direction. For effective heating action, the first and second heat outlets 112 and 114 can be placed substantially throughout the front side 102B and top 102C of the housing 102. A lateral side 102D of the housing 102 can include a plurality of control buttons 116, switches, or the like for controlling operation of the heater apparatus 100. The lateral side 102D can also include a drawer 118 that can be opened or closed into the housing 102 for convenient storage of diverse accessory parts, such as a remote controller (not shown) of the heater apparatus 100, power cords and plugs and the like. For facilitating transport of the heater apparatus 100, handles 120 can also be provided on the opposite lateral sides 102D and 102E near the top of the housing 102. A user can grasp the handles 120 deployed outward to conveniently transport or carry the heater apparatus 100. When they are not manipulated, the handles 120 can fit snugly into respective recessed portions 121 provided on the lateral sides 102D and 102E. As described in details hereafter, the lateral side 102E of the housing 102 opposite the lateral side 102D can also include a control element embodied as a rotary knob 164 for opening and closing the second heat outlet 114.

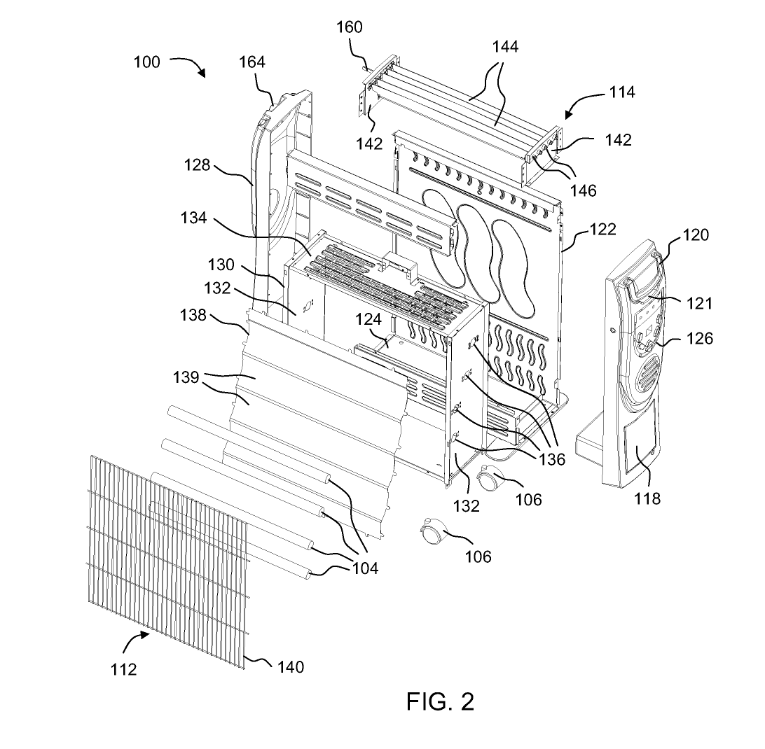

FIG. 2 is an exploded view illustrating the construction of the heater apparatus 100. In one embodiment, the housing 102 of the heater apparatus 100 can be formed by the assembly of a plurality of panels, including a rear panel 122, bottom panel 124 and two side panels 126 and 128. Each of the panels 122, 124, 126 and 128 may be made of rigid materials, such as steel alloy, aluminum alloy, plastics or the like. In one embodiment, the panels 122 and 124 may be made of a sheet metals to provide a rigid and heat-resistant structure, whereas the panels 126 and 128 may be made of molded plastics. The panels 122, 124, 126 and 128 can be fixedly joined with one another to form the envelope of the housing 102 provided with an inner volume for mounting the heating elements 104, and two major openings for forming the first heat outlet 112 and second heat outlet 114 that are in communication with the inner volume of the housing 102. In addition, the side panel 126 mounted at the lateral side 102D can include an opening through which the drawer 118 can be movably assembled.

As shown in FIG. 2, a support frame 130 can be fixedly attached inside the housing 102 for facilitating the assembly of the heating elements 104. An air gap is preferably left between the support frame 130 and the housing 102 to avoid heating of the housing 102 during operation. In one embodiment, the support frame 130 can have two opposite upright sidewalls 132 and a perforated top panel 134 adjoined approximately perpendicular between the two sidewalls 132. The top panel 134 may be made of any materials that can facilitate upward heat transfer by convection. Each of the sidewalls 132 can include a plurality of mount holes 136 for attaching the heating elements 104 between the two sidewalls 132 and below the perforated top panel 134, at parallel spaced-apart positions along a height direction H of the housing 102 (FIG. 1). As shown by the placement of the mount holes 136, the positions of the heating elements 104 can be arranged such that their respective projections on each of a first plane parallel with the perforated top panel 134 and a second plane parallel with the front side 102B are misaligned from one another. For example, the lowest heating element 104 can be placed proximate to the front side 102B of the heater apparatus 100, and each upward heating element 104 can be successively offset rearward toward the rear panel 122. Such distribution of the heating elements 104 can avoid or at least reduce obstructing overlap of the heating elements 104, and facilitate heat dispersion laterally along the first direction through the first heat outlet 112 and upwardly along the second direction through the perforated top panel 134 and second heat outlet 114.

For promoting heat extraction from the inside of the housing 102, a heat reflector 138 including curved portions 139 can also be provided adjacent to the heating elements 104. The heat reflector 138 can be affixed to the sidewalls 132 at a position between the heating elements 104 and rear panel 122. The heat reflector 138 generally lies along a direction that is inclined relative to the height direction H of the housing 102, so that each curved portion 139 respectively facing one heating element 104 can effectively redirect heat toward the first and second heat outlets 112 and 114. With this arrangement of the heat reflector 138, a first inner volume containing the heat elements 104 and at least partially delimited between a front surface of the heat reflector 138, the top perforated panel 134 and the first heat outlet 112 can be isolated from a second inner volume at least partially delimited between a rear surface of the heat reflector 138, the rear panel 122 and bottom of the support frame 130. Heat loss toward the rear and bottom of the heater apparatus 100 can thus be advantageously prevented.

As shown in FIGS. 1, 2 and 3, the first heat outlet 112 can include a grill 140 fixedly secured on the front side 102B of the housing 102. The grill 140 can prevent accidental contact with the heating elements 104, while allowing heat transfer by irradiation and convection substantially throughout the front side 102B.

In conjunction with FIGS. 1, 2 and 4, FIGS. 7 and 8 are schematic views illustrating one embodiment of the adjustable second heat outlet 114. The adjustable second heat outlet 114 is placed at a location that substantially overlies the perforated top panel 134. The second heat outlet 114 can include two brackets 142 respectively affixed on the side panels 126 and 128, and a plurality of shutter blades 144 that are movably mounted between the two brackets 142 along a direction parallel with the width direction W of the housing 102. The shutter blades 144 can be made of any heat-resistant materials. The shutter blades 144 can be rotated parallel to either close or open the second heat outlet 114 for selectively allowing upward heat convection. For this purpose, each of the shutter blades 144 can be pivotally assembled through the opposite brackets 142 via a respective hinge 146. The shutter blades 144 can be distributed parallel and spaced-apart from one another so as to define a plurality of gaps 150 interposed between adjacent shutter blades 144. Each shutter blade 144 has a leaf portion 144A that can be sized and shaped so as to entirely occlude one adjacent gap 150 when the second heat outlet 114 is in a closed state, and expose the gap 150 when the second heat outlet 114 is in an opened state.

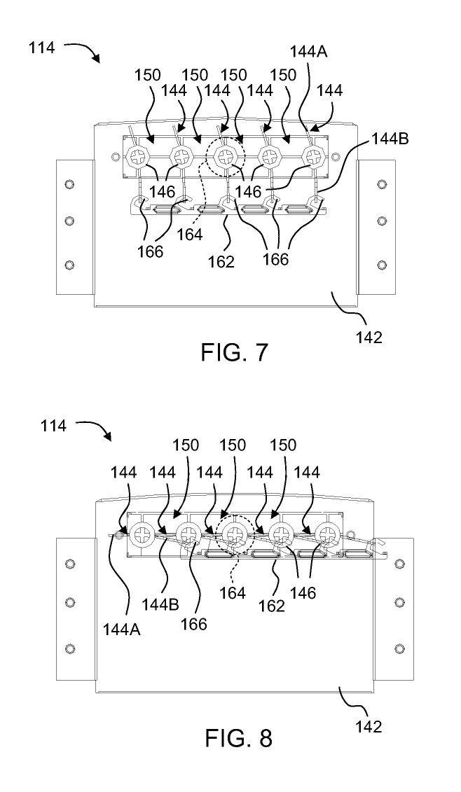

For operating all of the shutter blades 144 in unison, one embodiment can use an actuator mechanism that includes a drive shaft 160 (FIG. 2) and a coupling link 162. In the illustrated embodiment, this actuator mechanism can be exemplary provided proximate to the lateral side 102E of the housing 102 (FIG. 1). In alternate embodiments, the actuator mechanism can also be assembled at other locations, e.g., on the lateral side 102D of the housing 102. A first end of the drive shaft 160 is coupled coaxially with one of the shutter blades 144 (e.g., the central shutter blade 144) through the associated hinge 146. A second end of the draft shaft 160 is pivotally mounted relative to the side panel 128 and connected with a rotary knob 164 mounted on an outer surface of the side panel 128 on the lateral side 102E of the housing 102. In turn, the coupling link 162 is connected with each of the shutter blades 144 so that rotation of the drive shaft 160 coupled with one single shutter blade 144 can be transmitted to all of the other shutter blades 144 via the coupling link 162. As shown in FIG. 7, the coupling link 162 can have an elongated shape provided with a plurality of hooks 166. Each hook 166 can movably engage through an opening formed in an extending portion 144B of each shutter blade 144 located opposite the leaf portion 144A. Rotation of the knob 164 can be transmitted through the drive shaft 160 to the shutter blade 144 that is coaxially connected with the drive shaft 160. As the shutter blade 144 coupled with the drive shaft 160 rotates, the same rotation movement can be transmitted through the coupling link 162 to all of the other shutter blades 144.

During operation, the second heat outlet 114 can be switched to an open state (as shown in FIGS. 1, 4 and 7) by having the shutter blades 144 substantially expose the gaps 150. As a result, heat can spread by irradiation and convection laterally in the first direction through the first heat outlet 112, and mostly by convection upwardly in the second direction through the perforated top panel 134 and second heat outlet 114. This configuration may be particularly suitable for spreading heat in multiple directions to heat a surrounding space (e.g., the interior of a room) in an efficient manner. It is worth noting that the openings formed through the perforated top panel 134 are much smaller than the gaps 150 in size, and the perforated top panel 134 occupies a surface area that substantially overlaps with the opening of the second heat outlet 114. When the second heat outlet 114 is in the open state, the perforated top panel 134 can thus retain and block small objects that may accidentally fall through the gaps 150 and cause damaging contact with the underlying heating elements 104.

When only one direction of heating is desired, the second heat outlet 114 can be closed by rotation of the knob 164. The rotation movement of the knob 164 can be transmitted via the drive shaft 160 and coupling link 162 to all of the shutter blades 144 that accordingly occlude the gaps 150 (as illustrated in FIG. 8). In this closed state, upward heat spread through the second heat outlet 114 can be blocked. Accordingly, heat spread can be concentrated in the first direction through the first heat outlet 112 for providing local heating of a region proximate to the front side 102B.

By rotating the knob 164 in a reverse direction, a user can open the shutter blades 144 so as to restore heat spread through the second heat outlet 114. It is worth noting that the shutter blades 144 in the open state can also be adjustably turned to different angles of inclination by rotation of the knob 164. Consequently, the size of the opening through the second heat outlet 114 (i.e., defined by the gaps 150 between the shutter blades 144) can be modified for adjusting the desired amount of heat spread in the second direction.

At least one advantage of the heater apparatus described herein is the ability to selectively open or close at least one of a plurality of heat outlets so that heat can be spread along one or more privileged directions. Accordingly, the heater apparatus can be configured in a more versatile manner for adapting to different situations of use.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A heater apparatus comprising:
a housing; and
a plurality of heating elements provided in the housing;
wherein the housing includes a front side provided with a first heat outlet for spreading heat in a first direction, and a top provided with a second heat outlet for spreading heat in a second direction perpendicular to the first direction, the second heat outlet being operable to switch between a closed state for blocking heat spread and an open state enabling heat spread in the second direction.

2. The heater apparatus according to claim 1, wherein the first heat outlet includes a grill.

3. The heater apparatus according to claim 1, wherein the second heat outlet includes a plurality of shutter blades pivotally movable to close or open a plurality of adjacent gaps.

4. The heater apparatus according to claim 3, wherein the second heat outlet further includes:
a drive shaft coupled with one of the shutter blades;
a coupling link connected with each of the shutter blades; and
a knob externally affixed with the drive shaft.

5. The heater apparatus according to claim 1, wherein the heating elements are affixed on a support frame mounted in the housing.

6. The heater apparatus according to claim 5, wherein the support frame includes a perforated top panel located between the second heat outlet and the heating elements.

7. The heater apparatus according to claim 6, wherein the heating elements are arranged such that respective projections thereof on each of a first plane parallel with the perforated top panel and a second plane parallel with the front side are misaligned from one another.

8. The heater apparatus according to claim 7, wherein the heating elements are laid along a height direction of the housing at spaced-apart positions successively offset rearward.

9. The heater apparatus according to claim 7, further including a heat reflector placed at an inclined position relative to a height of the housing.

10. The heater apparatus according to claim 1, wherein the housing further includes a drawer movable to extend outside the housing and retract within the housing.

11. A heater apparatus comprising:
a housing; and
a plurality of heating elements provided in the housing;
wherein the housing includes a plurality of heat outlets for respectively spreading heat through a plurality of directions, the heat outlets including at least one adjustable heat outlet operable to switch between a closed state for blocking heat spread and an open state enabling heat spread there-through.

12. The heater apparatus according to claim 11, wherein the adjustable heat outlet is provided on a top of the housing.

13. The heater apparatus according to claim 11, wherein the adjustable heat outlet includes a plurality of shutter blades pivotally movable to close or open a plurality of adjacent gaps.

14. The heater apparatus according to claim 13, wherein the adjustable heat outlet further includes:
a drive shaft coupled with one of the shutter blades;
a coupling link connected with each of the shutter blades; and
a knob externally affixed with the drive shaft.

15. The heater apparatus according to claim 11, wherein the heating elements are affixed on a support frame mounted in the housing.

16. The heater apparatus according to claim 15, wherein the support frame includes a perforated top panel located between the adjustable heat outlet and the heating elements.

17. The heater apparatus according to claim 16, wherein the heating elements are arranged such that respective projections thereof on each of a first plane parallel with the perforated top panel and a second plane parallel with a front side of the housing are misaligned from one another.

18. The heater apparatus according to claim 17, wherein the heating elements are laid along a height direction of the housing at spaced-apart positions successively offset rearward.

19. The heater apparatus according to claim 11, further including a heat reflector placed at an inclined position relative to a height of the housing.

20. The heater apparatus according to claim 11, wherein the housing further includes a drawer movable to extend outside the housing and retract within the housing.

21. The heater apparatus according to claim 13, wherein the shutter blades are adjustable to different angles of inclination for varying a size of the adjacent gaps.
